(19) United States
(12) Patent Application Publication
(10) Pub. No.: US 2026/0218833 A1
(43) Pub. Date: Jul. 30, 2026

(54) Systems and Methods for Compressor Tubing Vibration Mitigation

(71) Applicant: Rheem Manufacturing Company, Atlanta, GA (US)

(72) Inventors: Aaron Patrick Gorman, New Braunfels, TX (US); Sohail Ahmed, Montgomery, AL (US); Kevin Lyle Eicher, Seguin, TX (US)

(73) Assignee: Rheem Manufacturing Company, Atlanta, GA (US)

(21) Appl. No.: 19/457,992

(22) Filed: Jan. 23, 2026

Related U.S. Application Data
(60) Provisional application No. 63/751,749, filed on Jan. 30, 2025.

(51) Int. Cl. F16L 55/04; F16L 3/10; F25B 31/00

(52) U.S. Cl. CPC F16L 55/041; F16L 3/10; F25B 31/00; F25B 2500/13

(57) ABSTRACT

Described herein are systems and methods for compressor tubing vibration mitigation. Particularly, a compressor system is described herein including one or more apparatuses (referred to as “clamps” herein) that are used to restrict the movement of the compressor tubing to eliminate or mitigate vibrations of the compressor tubing during operation of the compressor. The one or more clamps may be separate components from the compressor that are configured to be installed around the compressor. Once the one or more clamps are installed around the compressor, the compressor tubing may be inserted into tubing protrusions that extend outward from the one or more clamps.

### CROSS-REFERENCE TO RELATED APPLICATION

This application claims the benefit of US Application No. 63/751,749, filed January 30, 2025, the entirety of which is hereby incorporated by reference.

### TECHNICAL FIELD

The present disclosure is generally in the field of heating and/or cooling appliances.

### BACKGROUND

A compressor is a component commonly included within a refrigerant loop of a heating, ventilation, and air conditioning (HVAC) system. The compressor operates to compress and circulate refrigerant through the HVAC system. The compressor receives low-pressure, cool refrigerant gas from an evaporator coil in the refrigerant loop. The compressor compresses this gas, raising both the pressure and temperature of the gas. This high-pressure, hot refrigerant gas flows out of the compressor and into a condenser coil in the refrigerant loop. In the condenser coil, the gas releases heat to the outside air and cools down, eventually condensing into a high-pressure liquid. The refrigerant transitions into a liquid state and moves toward an expansion valve, where the pressure of the refrigerant is reduced. As the refrigerant enters the evaporator coil, the refrigerant absorbs heat from the indoor air, evaporating into gas again, and the refrigerant cycle repeats.

As the Department of Energy (DOE) continues to impose higher and higher minimum efficiency requirements on HVAC systems, manufacturers are transitioning to variable speed compressors. Single speed compressors only run at one speed and therefore it is easy to control the amplitude of the frequency response (vibrations) in the tubing system and the noise generated by the vibrations. Variable speed compressors may operate at multiple frequencies (for example, 10Hz to 120Hz) and can run at any 1Hz increment within a large range. This complicates the noise and vibration responses because any one of the frequencies could excite a natural frequency response, leading to high displacements in the refrigerant tubing. These vibrations may result in greater stresses on and lower fatigue life of the tubing.

### BRIEF DESCRIPTION OF THE DRAWINGS

FIG. 1A illustrates a perspective view of a compressor system with vibration reducing clamps, in accordance with one or more embodiments of the disclosure.

FIG. 1B illustrates a rear view of the compressor system of FIG. 1A, in accordance with one or more embodiments of the disclosure.

FIG. 1C illustrates another perspective view of a compressor system with vibration reducing clamps, in accordance with one or more embodiments of the disclosure.

FIG. 1D illustrates a top-down view of the compressor system of FIG. 1A, in accordance with one or more embodiments of the disclosure.

FIG. 1E illustrates a bottom-up view of the compressor system of FIG. 1A, in accordance with one or more embodiments of the disclosure.

FIG. 1F illustrates a perspective view of another compressor system with vibration reducing clamps, in accordance with one or more embodiments of the disclosure.

FIG. 2A illustrates a perspective view of exemplary tubing clamps, in accordance with one or more embodiments of the disclosure.

FIG. 2B illustrates a top-down view of tubing insertion into a tubing clamp, in accordance with one or more embodiments of the disclosure.

FIG. 2C illustrates a top-down view of a tubing clamp with tubing inserted, in accordance with one or more embodiments of the disclosure.

FIGS. 2D-2E illustrate close-up views of a tubing protrusion of a tubing clamp, in accordance with one or more embodiments of the disclosure.

FIGS. 3A-3B illustrate perspective views of another compressor system with a vibration reducing base, in accordance with one or more embodiments of the disclosure.

FIG. 4 illustrates an exemplary heating and/or cooling appliance including the compressor system of FIG. 1A, in accordance with one or more embodiments of the disclosure.

FIGS. 5A-5B illustrate perspective views of yet another compressor system with a vibration reducing base, in accordance with one or more embodiments of the disclosure.

### DETAILED DESCRIPTION

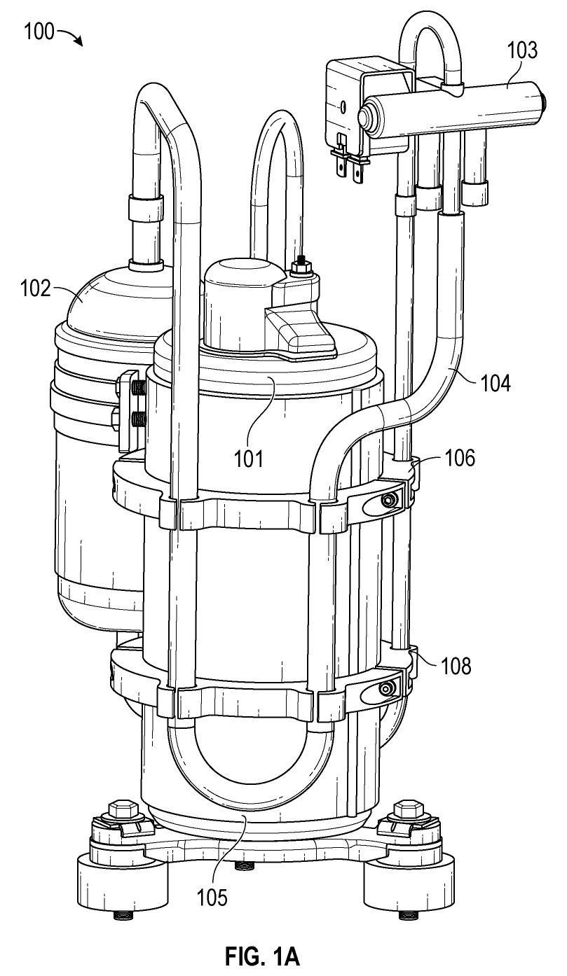

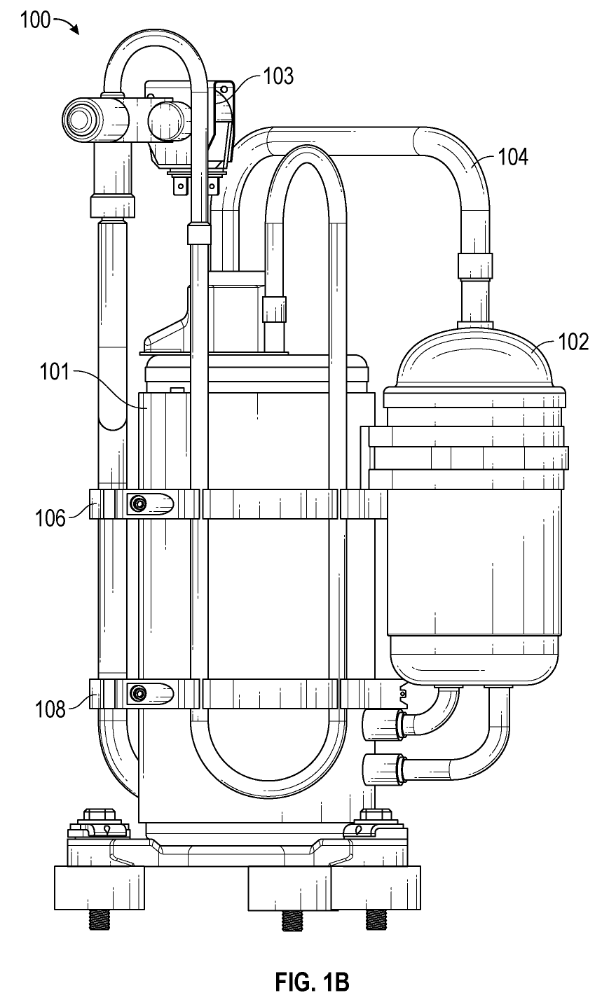

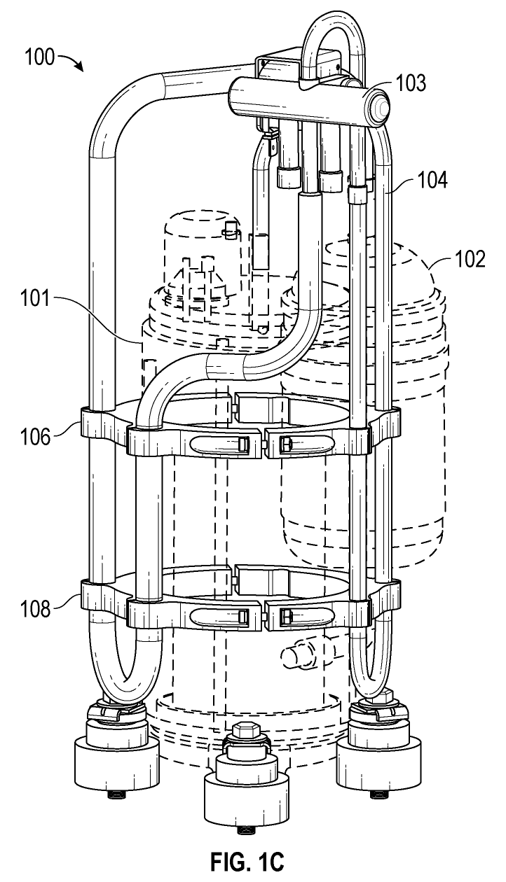

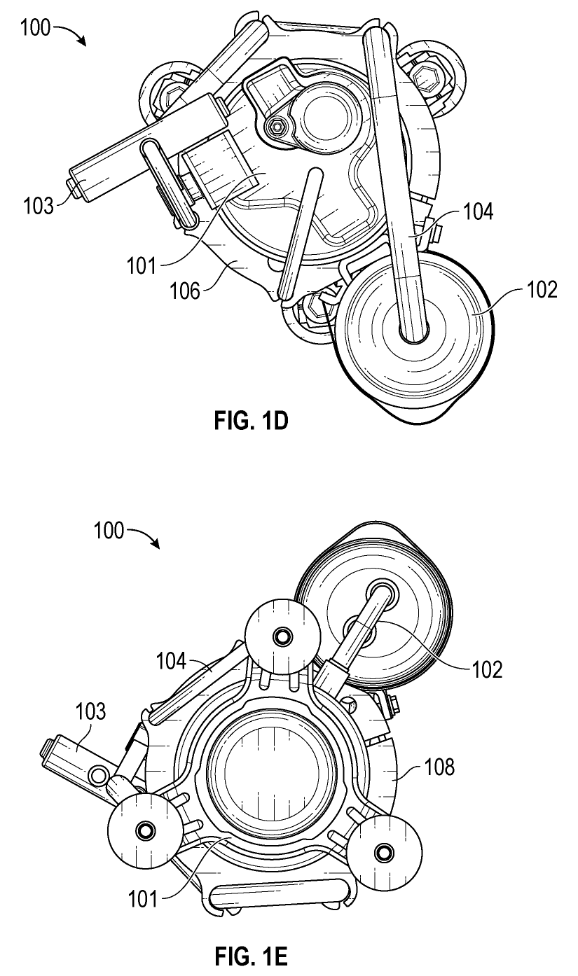

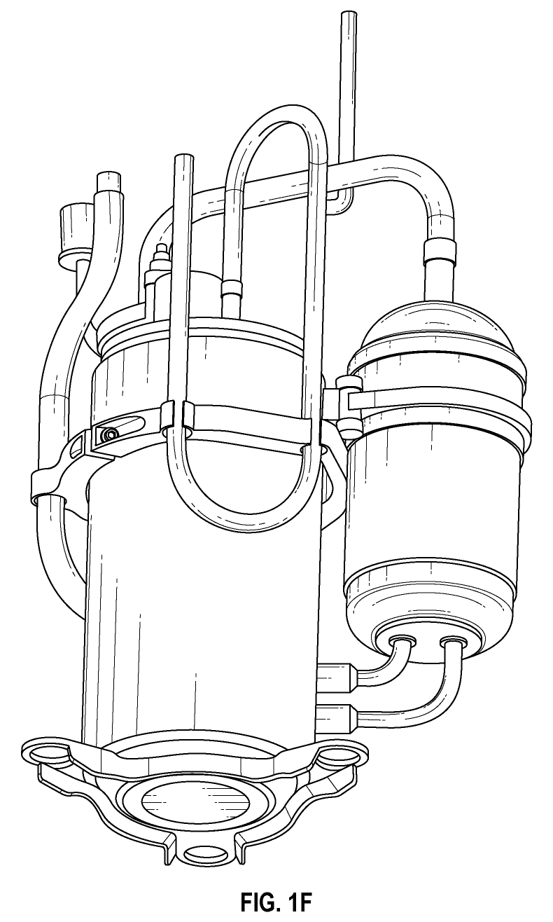

The present disclosure is directed to systems and methods for compressor tubing vibration mitigation. Particularly, a compressor system is described herein that includes one or more apparatuses that are used to restrict the movement of the compressor tubing to eliminate or mitigate vibrations of the compressor tubing during the operation of the compressor. As used herein, the term “compressor system” may refer to a compressor and other components of a refrigerant loop that are in fluid communication with the compressor (for example, an accumulator and reversing valve as shown in FIG. 1A). The compressor system may also include the tubing that connects these various components (for example, the tubing may carry refrigerant or other types of fluids between the various components). The term “fluid communication” may generally refer to the ability of fluids, such as refrigerant or any other type of fluid, to flow between the various components of the compressor system (such as through the tubing that connects the various components).

The compressor system may be a subset of a larger system, such as a heating and/or cooling appliance. A heating and/or cooling appliance may generally refer to any system configured to heat and/or cool the air in a conditioned space, such as a heating, ventilation, and air conditioning (HVAC) system. Non-limiting examples of such systems may include heat pumps, gas furnaces, air conditioning systems, etc. However, a heating and/or cooling appliance may not necessarily be limited to heating and/or cooling air. As another example, a heating and/or cooling appliance may generally refer to any system configured to produce a heated fluid, such as a water heater, a boiler, a pool heater, etc. A heating and/or cooling appliance may also be used to heat and/or cool any other fluid, such as a gas, liquid, etc. Yet further examples of heating and/or cooling appliances may include integrated heat pump water heaters (HPWHs), monobloc/split HPWHs, Packaged HVAC units, split HVAC units, etc. Although some figures illustrated herein show a particular type of heating and/or cooling appliance, this is merely for illustrative purposes and is not intended to limit the type of heating and/or cooling appliance that is applicable. One of ordinary skill in the art would appreciate that these are merely examples of types of heating and/or cooling appliances and the clamps (or any other type of apparatus) described herein may also be applicable to any other type of system that includes a compressor and tubing in fluid communication with the compressor.

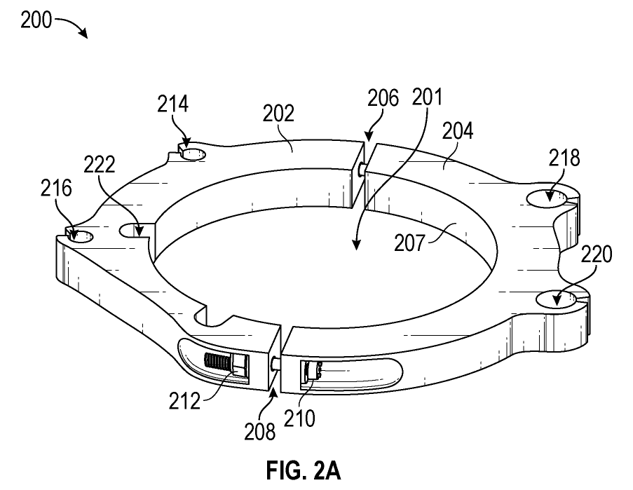

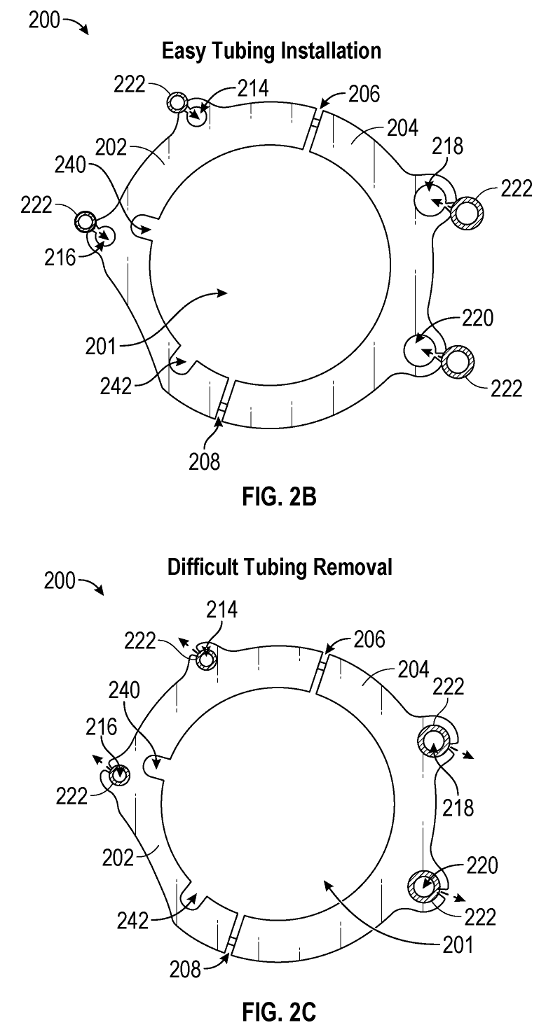

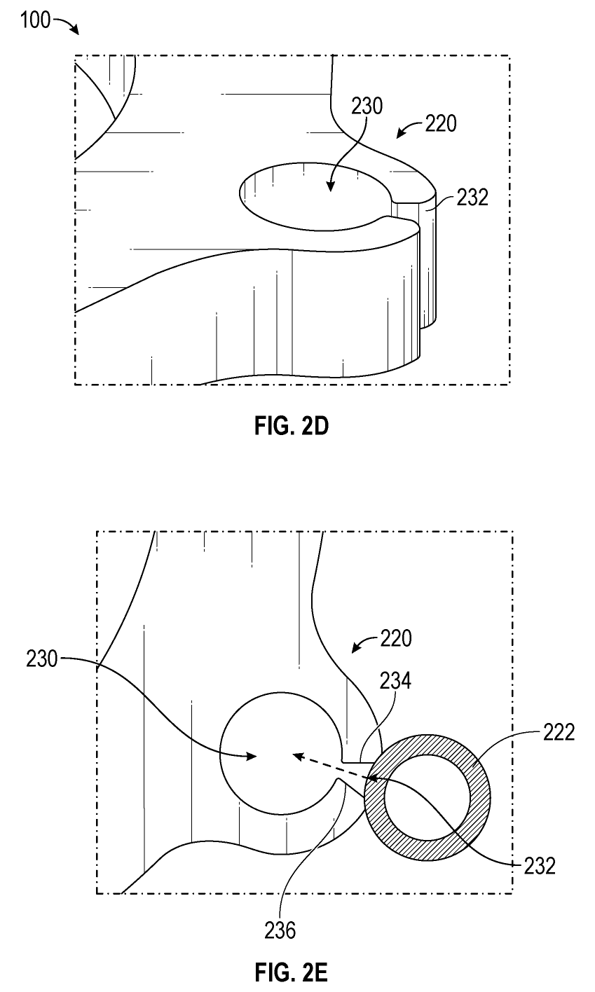

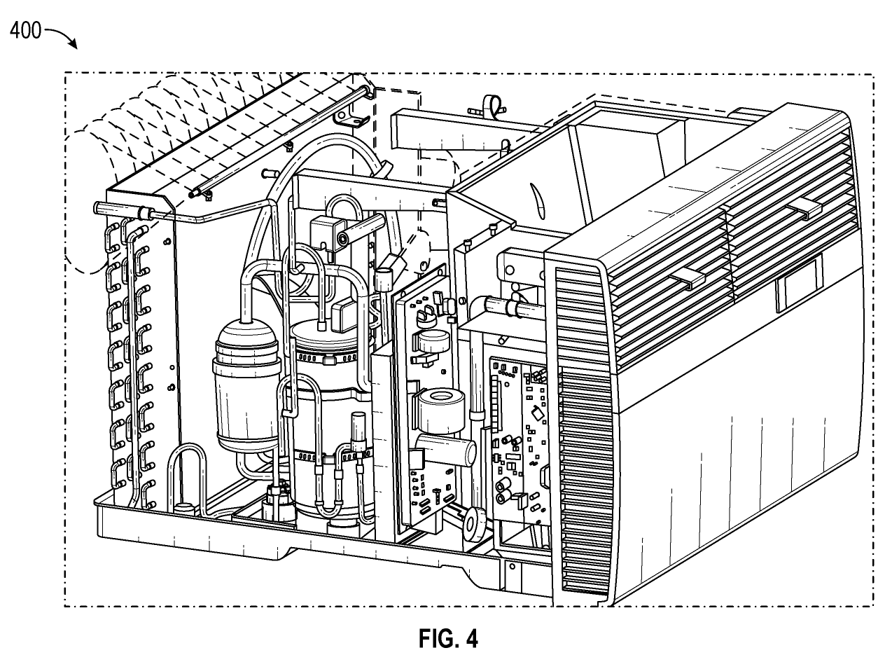

The one or more clamps may be separate components from the compressor that are configured to be installed around the compressor. For example, the one or more clamps may be installed around the compressor during the manufacturing of a heating and/or cooling appliance when the compressor system is added inside the heating and/or cooling appliance (however, the one or more clamps may also be installed at any other time, such as during installation of the heating and/or cooling appliance at a location such as a residential home or commercial building). Once the one or more clamps are installed around the compressor, the compressor tubing may be inserted into tubing protrusions that extend outward from the one or more clamps. In some instances, the tubing may also be brazed after insertion into the one or more clamps. Example illustration of compressor systems including the one or more clamps are shown in at least FIGS. 1A-1F and 4 and illustrations of the clamps themselves are shown in at least FIGS. 2A-2E (all of these figures are described in further detail below).

The tubing protrusions extend outward from the clamps and may include cavities that are sized and shaped to securely hold the tubing in place and restrict the movement of the tubing (for example, to restrict the vibration of the tubing). To allow for the installation of the tubing into the cavities (and the removal of the tubing from the cavities), each of the tubing protrusions may also include a notch. The notch may be sized and shaped such that the tubing can be inserted into the cavity through the notch but remains within the cavity unless sufficient force is provided to remove the tubing from the cavity (for example, a user forcibly pulling the tubing out of the cavity). Specifically, in one or more embodiments, the notch may include sidewalls that are angled inward towards the cavity. Accordingly, the notch is larger at the exterior-facing portion of the notch where the tubing is initially inserted into the notch and there is less structure to resist the insertion of the tubing into the notch. However, the notch is also smaller at the portion of the notch more proximal to the cavity such that there is more structure to resist the removal of the tubing from the notch. Thus, the tubing can remain secure within the cavity unless sufficient force is applied by a user to pull the tubing through the smaller portion of the notch.

In one or more embodiments, the clamps may include individual halves that may be combined around the compressor during installation. If it is desired to remove the clamps from the compressor, then the two halves may be separated and removed from the compressor. For example, as is shown in FIGS. 2A-2E, the clamps may include two halves that may be combined using fasteners at interfaces between the two halves. However, a clamp may also be formed as a combination of any other number of individual components. In further embodiments, a clamp may also be a singular structure that is not separable into multiple distinct parts. In yet further embodiments, a clamp may also be formed as an integrated structure of the compressor itself.

The use of the vibration reducing clamps provides a number of benefits to a compressor system. First, the clamps provide vibration damping to reduce tubing displacement and absorb at least some of the energy generated by the compressor and other components. Second, the clamps tie the movement of the tubing to the movement of the compressor (the tubing is fixed to the clamps and the clamps are (potentially removably) fixed to the compressor) to reduce differential displacements between the compressor and the tubing, which reduces vibration-induced bending stresses in the tubing. Third, the clamps serve as an assembly fixture, such that the tubing position and orientation are consistent across compressor installations. Less variation in the assembly process leads to more consistent vibration responses. Fourth, the clamps allow for much shorter tubing routing to be used (for example, shown in FIG. 1F) to reduce cost, increase air flow, and decrease weight by routing the tubing closer to the compressor body. Close coupling of the tubing and components to the compressor center of rotation also helps reduce tubing displacements. Fifth, the clamps reduce noise by reducing the vibration amplitude at the compressor and tubing. This eliminates the need for a compressor blanket to reduce noise to acceptable levels. Sixth, the clamps allow for vibration response tuning by adjusting the clamp material stiffness, mass, position, clamping force of the clamps, and number of clamps. Seventh, the clamps improve the fatigue life of the tubing and possibly the compressor, leading to more reliable and systems with longer life spans.

There may be other approaches to reduce tubing vibrations in a compression system. For example, it is possible to implement “skip bands” in the control software for the compressor system (or the heating and/or cooling appliance in which the compressor system is located) to prevent the compressor from operating at resonance frequencies. That is, the control software may be configured to avoid operating the compressor at the resonant frequency of the tubing. However, these methods counteract the purpose of having variable speed compressors (that is, the advantage of variable speed compressors is that they should be able to run at whatever frequency satisfies the load condition most efficiently). By instead adding damping to the system and controlling the relative movement of the compressor and tubing using the clamps as described herein, the displacement of the tubing (and thus the stress of the tubing) decreases and the fatigue life of the tubing correspondingly increases.

Turning to the figures, FIGS. 1A-1E illustrate an exemplary compressor system 100. Specifically, FIG. 1A illustrates a perspective view of the compressor system 100 with vibration reducing clamps. FIG. 1B illustrates a rear view of the compressor system 100. FIG. 1C illustrates another perspective view of a compressor system 100. FIG. 1D illustrates a top-down view of the compressor system 100. FIG. 1E illustrates a bottom-up view of the compressor system 100. As mentioned above, the compressor system 100 may be a subset of components that are included in a larger system, such as a heating and/or cooling appliance. An example of such a heating and/or cooling appliance that includes the compressor system 100 is shown in FIG. 4 and described in further detail below.

In one or more embodiments, the compressor system 100 may include a compressor 101, an accumulator 102, a reversing valve 103, and tubing 104 that is in fluid communication with the compressor 101, accumulator 102, and reversing valve 103. That is, the tubing 104 may carry refrigerant or any other type of fluid between the various components of the compressor system 100 as a part of a conventional refrigerant loop. The compressor system 100 may be included within a larger heating and/or cooling appliance, such as the heating and/or cooling appliance 400 shown in FIG. 4.

One of ordinary skill in the art will appreciate that the specific configuration of the compressor system 100 shown in FIG. 1A is merely exemplary and other configurations may also be possible. For example, the compressor system 100 may include fewer or additional components. Any of the components may be any other size and/or shape and may be provided in any other arrangement with respect to any other the other components. Additionally, although the tubing 104 is shown as being routed between the various components in a specific manner, this is not intended to be limiting and the tubing 104 may also be routed in any other suitable manner. The tubing 104 may also be any other diameter or may be of varying diameter at different sections of the tubing 104.

Advantageously, the compressor system 100 also includes one or more clamps (for example, clamp 106 and clamp 108, or any other number of clamps) that are used to secure the tubing 104 in place within the compressor system 100 to eliminate or mitigate vibrations of the tubing 104 caused by operation of the compressor 101. As described above, in conventional compressor systems, the tubing would be routed between the various components and would be connected to inlets and outlets of the components in the compressor system but would not otherwise be secured to any structure within the compressor system. Accordingly, any vibrations resulting from the operation of the compressor would propagate through the tubing, resulting in noise generation by the tubing and also potential damage to the tubing over time.

By securing the tubing 104 within the one or more clamps, the tubing 104 is more securely fixed in place within the compressor system 100 than in a conventional compressor system. Specifically, the one or more clamps may include tubing protrusions with cavities such that the tubing 104 may be inserted into the tubing protrusions to secure the tubing 104 within the one or more clamps. During installation of the compressor system 100, the one or more clamps may initially be provided around the compressor 101 as shown in FIG. 1A and then the tubing 104 may be inserted into the tubing protrusions. In some instances, the tubing may also be brazed.

To further mitigate the vibrations caused in the tubing 104 by the operation of the compressor 101, the tubing 104 may be routed in the compressor system 100 in a manner that forms at least one bend in the tubing. For example, at least FIG. 1A shows a first bend 105 that is a 180 degree bend in the tubing 104 that is routed around the compressor 101. This bend 105 adds further structural rigidity to the tubing 104. Any other number of bends may also be provided in the tubing 104 in any other locations for similar purposes.

In one or more embodiments, the clamps may remain in place at the location in which they are installed around the compressor 101 by a friction force between the interior surface of the clamps and the outer surface of the compressor 101. For example, when a clamp is installed around the compressor 101, the clamp may be tightened around the compressor 101 such that the resulting friction force is sufficient to hold the clamp in place. The clamps may also be further secured in place using any other types of suitable mechanisms. As one non-limiting example, the clamps may also be fastened to the compressor 101. Further examples of mechanisms by which a clamp may remain secured in place around the compressor 101 are described with respect to at least FIGS. 2A-2E.

While FIGS. 1A-1E show an embodiment in which two clamps are provided in the compressor system 100, this is not intended to be limiting and any other number of clamps may also be provided. FIG. 1F illustrates a perspective view of the compressor system 100 with only the clamp 106, for example. A compressor system 100 may also include three clamps, four clamps, etc. The clamps may be arranged along the compressor 101 at various locations depending on the specific configuration of the compressor system 100 and the manner in which the tubing 104 is routed in the compressor system 100. The embodiment shown in FIG. 1F also shows that the length of the tubing 104 is shorter than in the embodiment shown in FIGS. 1A-1E in which two clamps are used. The shorter tubing 104 length in this embodiment serves the dual purpose of further mitigating the vibrations in the tubing 104 given that the length of the tubing 104 is reduced.

As shown in at least FIG. 1B, the accumulator 102 may be mounted directly to the compressor 101 (for example, using a mounting bracket) without interfering with the clamp 106 or the clamp 108. However, this configuration is not intended to be limiting and the accumulator 102 may instead be mounted to the clamp 106 and/or the clamp 108 (or may at least be in contact with the clamp 106 and/or the clamp 108 to provide damping between the accumulator 102 and the compressor 101).

FIG. 2A illustrates a perspective view of an exemplary tubing clamp 200. The clamp 200 is configured to be installed around a compressor (for example, compressor 101 or any other compressor described herein or otherwise). The clamp 200 may include an interior surface 207 that is in contact with the outer surface of the compressor when the clamp 200 is installed around the compressor. The clamp 200 remains fixed in place at the location in which the clamp 200 is installed by a friction force between the interior surface 207 of the clamp 200 and the outer surface of the compressor. However, as indicated previously, the clamp 200 may be further secured in place against the compressor using any other suitable mechanism in addition to the friction force.

In the example embodiment shown in FIG. 2A, the clamp 200 includes a first half 202 and a second half 204. The first half 202 and the second half 204 may be removably attached to one another. That is, the first half 202 and the second half 204 may initially be separate components but may be combined around the compressor to form the single clamp structure around the compressor as shown in FIG. 1A, for example. When combined, the first half 202 and the second half 204 may form the interior surface 207 that is in contact with the outer surface of the compressor when the clamp 200 is installed around the compressor. In a similar manner, the clamp 200 may be removed from the compressor by separating the first half 202 and the second half 204. The interior of the clamp 200 may form a void 201 between the first half 202 and the second half 204 when the first half 202 and the second half 204 are combined around the compressor and the void 201 may be sufficiently large such that the compressor may be received within the void 201.

Providing the clamp 200 as a combination of components that may be separated provides a number of advantages. One advantage is that the clamp 200 may be easily installed on a compressor at any location on the compressor. The clamp 200 may also be easily removed from the compressor, if desired. For example, it may be desired for the clamp 200 to be removed from one compressor and installed on another compressor if an original compressor is replaced with another compressor (or for any other reason). As another example, if the clamp 200 is damaged, then the clamp 200 is easily removable to be replaced with another clamp.

Another advantage is that there is adjustability in the size of the clamp 200 such that the clamp 200 may be used on different compressor sizes. If the clamp 200 were formed as a single structure, then the circumference of the void 201 within the clamp 200 would be fixed and thus the clamp 200 would only be suitable for use with a compressor that is compatible with that fixed circumference. In contrast, the two halves in the embodiment shown in FIG. 2A do not necessarily always need to be fully combined such that the first half 202 and the second half 204 are in contact at the first interface 206 and the second interface 208. For example, FIG. 2A shows a gap between the first half 202 and the second half 204 at the first interface 206 and the second interface 208. The size of this gap may be adjusted to increase the size of the void 201 to accommodate for different sizes of compressors. If it is desired to install the clamp 200 on a compressor of a larger circumference, then the gap between the first half 202 and the second half 204 at the first interface 206 and the second interface 208 may be increased. This may be accomplished in any number of different ways. As one non-limiting example, spacers may be provided at the first interface 206 and the second interface 208 between the first half 202 and the second half 204. However, the size of the gaps at the first interface 206 and the second interface 208 may be adjusted in any other way.

Although the clamp 200 is shown as including two halves in FIG. 2A, this is merely one exemplary embodiment and is not intended to be limiting. The clamp 200 may also be formed from any other number of individual sections that may be combined to form the singular clamp 200 that is provided around the compressor. Additionally, in some instances, the clamp 200 may be formed as one structure rather than multiple portions that are combined.

In one or more embodiments, the first half 202 and the second half 204 may be combined at a first interface 206 and a second interface 208 using fastening hardware. For example, FIG. 2A shows that a bolt 210 is provided through a first aperture located on the first half 202 at the second interface 208 and a corresponding second aperture located on the second half 204 at the second interface 208 (the apertures are not visible in the perspective shown in FIG. 2A). A nut 212 may be threaded onto the bolt to secure the first half 202 of the clamp 200 to the second half 204 at the interface 208. Although not visible in the perspective shown in FIG. 2A, similar fastening hardware may be used to secure the first half 202 to the second half 204 at the first interface 206. In this exemplary embodiment, the nut 212 may be unthreaded from the bolt 210 at the second interface 208 (and the nut at the first interface 206 may also be unthreaded) to separate the first half 202 and the second half 204 to remove the clamp 200 from the compressor.

The use of the bolt 210 and the nut 212 is merely one example of a type of fastening hardware that may be used to secure the first half 202 and the second half 204 and any other types of fastening hardware may also be used. Further, it should be noted that there may be other mechanisms used to combine the two halves, and the use of fasteners in general is not intended to be limiting. As further non-limiting examples, rivets (such as metal or plastic rivets), zip-ties, or any other mechanism may be used in place of the bolt and nut.

In one or more embodiments, the clamp 200 may also include one or more tubing protrusions (for example, tubing protrusions 214, 216, 218, and 220) that are configured to receive the compressor tubing. That is, as described above with respect to FIG. 1A, during installation the clamp 200 may be provided around the compressor and then the compressor tubing may be inserted into the one or more tubing protrusions to secure the tubing to the clamp 200. In some instances, the tubing may also be brazed, however, this is not required. The one or more tubing protrusions are sized and shaped such that the tubing remains relatively fixed within the one or more tubing protrusions. This eliminates or at least reduces the vibrations experienced by the tubing during the operation of the compressor. By reducing the vibrations of the tubing, the noise produced by the system is reduced and the lifetime of the tubing is also increased (among other benefits described herein).

Although FIG. 2A shows a specific number of tubing protrusions that are arranged at specific locations on the clamp 200, this is not intended to be limiting and the tubing protrusions may also be configured in any other way. For example, any other number of tubing protrusions may be provided on the clamp 200 and the tubing protrusions may be provided at any other locations on the clamp 200. Additionally, the size and shape of the tubing protrusions may also vary. Furthermore, in one or more embodiments, rather than the clamp 200 including tubing protrusions that extend outward from the remaining structure of the clamp 200, the clamp 200 may instead include cavities that extend into the structure of the clamp (or the clamp 200 may include cavities in any other configuration that are capable of receiving and holding the tubing).

The tubing protrusions are provided at a distance from the compressor to separate the tubing from the compressor. However, given that the tubing protrusions hold the tubing fixed in place and eliminate or reduce the ability of the tubing to move (e.g., vibrate), the tubing may be held more proximate to the compressor than in a conventional compressor system that does not include the clamps. In a conventional compressor system, the tubing may need to be positioned further away from the compressor to prevent the vibrating tubing from contacting the compressor. For example, without the use of the clamp 200 as described herein, the tubing may conventionally not be closer than 0.25 inches away from the compressor. However, with the clamp 200, the tubing may be as close as .0625 inches from the compressor (these numbers are merely exemplary and not intended to be limiting). Thus, the use of the clamps 200 also allows for the package size of the compressor system to be at least partially reduced given that the tubing may be fixed in place closer to the compressor.

In some cases, a clamp 200 may be configured such that there may remain some amount of gap remaining between the first half 202 and the second half 204 at the first interface 206 and the second interface 208 of the clamp when the clamp 200 is fully tightened around the compressor. The clamp 200 may be configured in this manner such that the friction force between the interior surface 207 of the clamp 200 and the compressor is maximized to ensure the clamp 200 remains in place around the compressor. For example, to avoid the scenario where the clamp is fully tightened with the first half 202 and the second half 204 in contact with no gap at the first interface 206 and the second interface 208 and the clamp 200 is not sufficiently tight around the compressor to allow the clamp 200 to remain in place. However, this configuration is not necessarily required and the clamp 200 may also specifically be configured to be sufficiently tight around the compressor with no gaps at the first interface 206 and the second interface 208.

As mentioned elsewhere herein, the clamp 200 may be configured to accommodate various sizes and shapes of compressors given that the first half 202 and the second half 204 are combined. Accordingly, there may be no gap at the first interface 206 and the second interface 208 for a compressor that is smaller in diameter but there may be a gap at the first interface 206 and the second interface 208 for a compressor that is larger in diameter (e.g., for the compressor with the larger diameter, the clamp 200 may be fully tightened around the compressor before the first half 202 and the second half 204 are fully in contact at the first interface 206 and the second interface 208).

Additionally, in one or more embodiments, additional structure may be provided along some or all of the interior surface 207 of the clamp 200 to facilitate yet further force between the interior surface 207 and the compressor when the clamp 200 is installed on the compressor. For example, some or all of the interior surface 207 may be lined with a gasket, which may be formed from any type of at least partially compressible material. Using this type of at least partially compressible material may also allow for more contact between the interior surface 207 of the clamp 200 and the compressor if the shape of the compressor does not exactly align with the shape of the void 201 within the clamp 200. For example, if the void is circular or substantially circular and the compressor is at least partially oval, then a compressible material may fill in some of the gaps that may otherwise exist between portions of the exterior surface of the compressor and the interior surface 207 of the clamp 200 that may exist if the interior surface 207 is entirely rigid in structure. However, such a compressible material may not be required and the clamp 200 may have sufficient force against the compressor to remain fixed in place even if not all of the interior surface 207 of the clamp 200 is in contact with the compressor.

Furthermore, also as indicated elsewhere herein, the clamp 200 may be formed as an integrated structure of the compressor. In this embodiment, the clamp 200 would not need to rely on friction forces to remain in place on the compressor as the clamp 200 would be formed as a permanent structure of the compressor. In other embodiments, to retain the ability to remove the clamp 200 from the compressor, other structures may be provided to allow the clamp 200 to be mechanically affixed to the compressor. For example, a mounting bracket may be provided on the compressor and the clamp 200 may be fastened to the mounting bracket. One of ordinary skill in the art would appreciate that this is merely one example of a manner by which the clamp 200 could potentially be mechanically mounted to the compressor and other options also exist.

In embodiments in which the clamp 200 is mechanically mounted to the compressor (for example, using fasteners as mentioned above or in any other manner), it is not necessarily required that the clamp 200 be provided as a continuous structure around the compressor. For example, in other embodiments, only the sections of the clamp including the tubing protrusions (described further below) that hold the tubing 222 are fastened to the compressor, the tubing 222 may still be held within the tubing protrusions at the fixed distance from the compressor as shown in FIG. 1A.

FIGS. 2B-2C are top-down views of the clamp 200 illustrating the installation of the tubing 222 within the one or more tubing protrusions (FIG. 2B) and the removal of the tubing 222 from the one or more tubing protrusions (FIG. 2C). Beginning with the installation shown in FIG. 2B, the tubing 222 is inserted into the various tubing protrusions (for example, tubing protrusions 214, 216, 218, and 220, or any other number of tubing protrusions that may be included depending on the specific configuration of the compressor system). To insert the tubing 222 into the protrusions, a user (e.g., a technician, homeowner, etc.) holds the tubing 222 and applies a force on the tubing 222 against the portion of a tubing protrusion at which a notch is located. The tubing 222 initially comes into contact with the portion of the notch 232 at which the two sidewalls of the notch are further apart allowing for the tubing 222 to be more easily received within the notch 232. The tubing protrusion (at least at the location of the notch or the entire tubing protrusion) may be made from a material that has some degree of softness such that the force provided by the user causes the sidewalls of the notch 232 to separate to allow the tubing 222 to be pushed through the notch 232 and into the cavity of a given tubing protrusion.

As shown in FIG. 2C, the cavities of the various tubing protrusions may specifically be configured with diameters that are the same as (or substantially the same as) the diameter of the specific tubing 222 that is inserted into the tubing protrusions. This ensures that the tubing 222 remains fixed within the cavities and is unable to freely move within the cavities (unless a user applies another force to remove the tubing 222 from the cavities). As shown in FIG. 2C, the cavities are not necessarily all the same size and shape and may vary in size and shape depending on the specific section of the tubing 222 that is inserted into the particular cavity.

To remove the tubing 222 from the cavities, the user may again apply a force to pull the tubing 222 out of the cavities and back through the notches 232 and out of the tubing protrusions. The sidewalls of the notches 232 are closer together proximate to the cavities such that the tubing 222 is able to remain fixed within the cavities until the user applies the force to pull the tubing out 222. However, the gap proximate to the cavities and the material of the tubing protrusions (or at least the sidewalls of the notches) allows for the user to still pull the tubing 222 out through the notches 232 by applying sufficient force.

The perspectives shown in FIGS. 2B-2C also more clearly depict the structural features of the clamp 200. For example, the clamp 200 is configured as circular or substantially circular in shape to allow the clamp 200 to generally conform to the outer circumference of a generally cylindrically shaped compressor. However, this shape is not intended to be limiting and the shape may also vary depending on the shape of the compressor around which the clamp 200 is installed.

FIGS. 2B-2C also show that the clamp 200 may also be configured to accommodate components other than the tubing 222 depending on the configuration of the compressor system and/or other components in the larger heating and/or cooling appliance. For example, the first half 202 is shown as including a first relief cut-out 240 and a second relief cut-out 242. In this particular example, the first relief cut-out 240 and the second relief cut-out 242 are sized and shaped to receive tubing that is separate from the typical refrigerant loop including the tubing 222. For example, this separate tubing may be non-refrigerant, condensate management copper (or any other material) heat pipes. This non-refrigerant tubing may leverage heat from the compressor to keep defrost melt water in a liquid state and may be the inlet tubing for the suction side of the water pump. This is merely one example of tubing that is separate from the typical refrigerant loop and relief cut-outs may be provided to accommodate any other tubing or any other components in general.

While the examples shown in FIGS. 2B-2C show two relief cut-outs on the first half 202 of the clamp 200, this is merely exemplary and a clamp may also be configured in any other manner to accommodate any other types of components of any shapes and/or sizes that may be included in a given compressor system. As one non-limiting example, the first half 202 may include any other number of relief cut-outs. As another non-limiting example, the second half 204 may also (or alternatively) include relief cut-outs for similar types of tubing or other components. Any of these relief cut-outs may be any shape and/or size and may be positioned at any number of locations on the clamp 200.

FIGS. 2D-2E illustrate close-up views of tubing protrusion 220 of the clamp 200. Specifically, FIG. 2D shows a perspective view and FIG. 2E shows a top-down view. As shown in the figures, the tubing protrusion 220 includes a cavity 230 that receives and holds the tubing 222 when the clamp 200 is installed on the compressor and the tubing 222 is inserted into the clamp 200. To allow for the tubing 222 to be inserted into the cavity 230, the tubing protrusion 220 also includes a notch 232.

The notch 232 may be sized and shaped such that the tubing 222 is configured to be inserted into the cavity 230 through the notch 232 but remains within the cavity 230 unless a sufficient force is provided to remove the tubing 222 from the cavity 230 (for example, a user forcibly pulling the tubing 222 out of the cavity 230). Specifically, in one or more embodiments, the notch 232 may include a first sidewall 234 and a second sidewall 236 that are angled inward towards the cavity 230. Accordingly, the notch 232 is larger at the exterior-facing portion of the notch 232 where the tubing 222 is initially inserted into the notch 232 and there is less structure to resist the insertion of the tubing 222 into the notch 232. However, the notch 232 is also smaller at the portion of the notch 232 more proximal to the cavity 230 such that there is more structure to resist the removal of the tubing 222 from the notch 232. Thus, the tubing 222 is able to remain secure within the cavity 230 unless sufficient force is applied by a user to pull the tubing 222 through the smaller portion of the notch.

Furthermore, the clamp 200 (or any portion of the clamp 200) may be made from a material that facilitates an easier insertion of tubing into the clamp 200 and a more difficult removal of the tubing 222 from the clamp 200. Non-limiting examples of such materials may include ethylene propylene diene terpolymer (EPDM), Neoprene, Silicone, and/or Polyurethane. These materials are sufficiently stiff to prevent the tubing 222 from easily dislodging from the cavity 230 unless a sufficient force is applied but are also sufficiently soft such that a user is able to insert the tubing 222 into the cavity 230.

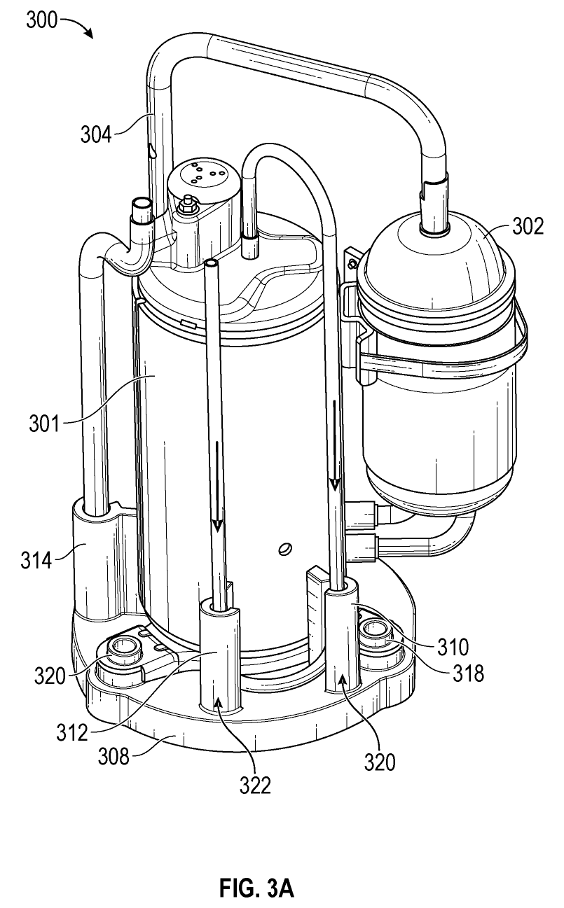

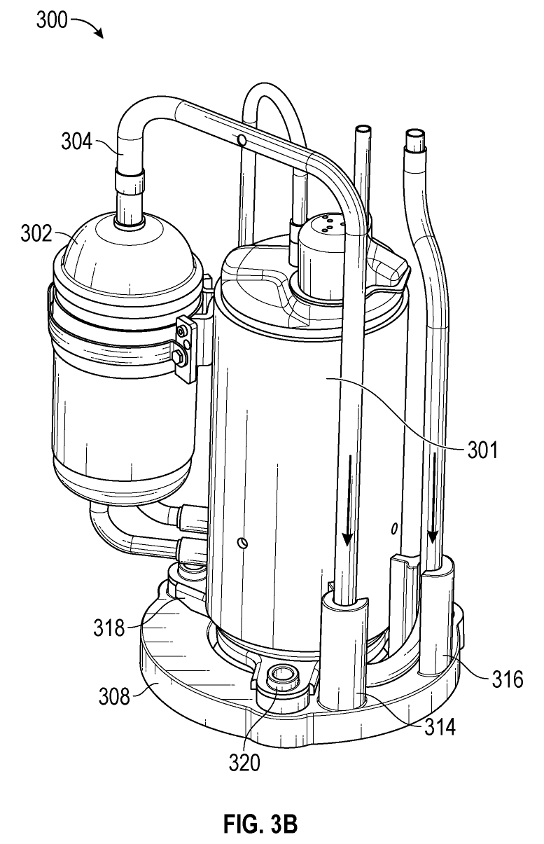

FIGS. 3A-3B illustrate perspective views of another compressor system 300 with a vibration reducing base. That is, the vibration reducing base 308 serves as an alternative to the clamps (for example, clamp 106, clamp 108, clamp 200, or any other clamp described herein) described herein in other embodiments (however, the base 308 and the clamps may also be used in combination, in some embodiments).

FIGS. 3A-3B show another compressor system 300 that is the same as, or similar to, the compressor system 100 shown in FIGS. 1A-1F. That is, the compressor system 300 may include a compressor 301, an accumulator 302, and the tubing 304 that connects the various elements of the compressor system 300. Although not shown in FIGS. 3A-3B, the compressor system 300 may also include a reversing valve and/or any other elements that are traditionally found in a system including a compressor.

The embodiment shown in FIGS. 3A-3B differs from the embodiments shown in FIGS. 1A-2E in that the compressor system 300 includes a base 308 that is used to restrict the movement of the tubing 304 during the operation of the compressor 301 (in a similar manner that the clamps 106, 108, 200, etc.) restrict the movement of the tubing 104 (or other tubing described herein) during the operation of the compressor 101. Specifically, the base 308 may include one or more tubing supports (for example, FIGS. 3A-3B show tubing supports 310, 312, 314, and 316, however, any other number of tubing supports may be provided). The tubing supports may be grommets, for example, or any other type of suitable structure. The tubing supports protrude upward from the base 308 and include hollow internal cavities such that the tubing 304 may be inserted into the tubing supports. The base 308 may also include compressor mounts (for example, compressor mount 318, compressor mount 320, and/or any other number of compressor mounts). The compressor mounts may be structures that allow for the compressor 301 to be securely mounted to the base. For example, a shoulder screw may be used to provide the appropriate compression of the grommet, or provide some gapping if desirable. In some instances, the shoulder screw threads directly into a metal base pan of the base 308, or a nut on the bottom side of the base pan can be used. However, the compressor 301 may be mounted to the base 308 using any other suitable mechanism.

The tubing supports may also include apertures, slots, or the like in the sidewalls of the tubing supports such that the tubing 304 is able to be routed into and through the side of the tubing supports. For example, FIG. 3A shows tubing that is routed into tubing support 310, through an opening 320 in a sidewall of the tubing support 310, into an opening 322 in tubing support 312, through tubing support 312, and back upwards and out of the tubing support 312. However, the tubing may be routed through tubing supports in any other suitable manner. The tubing supports may also be any other size and/or shape (for example, to accommodate any other size and/or shape of tubing 304) and may be arranged on the base 308 in any other suitable manner.

FIG. 4 illustrates an exemplary heating and/or cooling appliance 400 including a compressor system 402 (such as the compressor system 100 of FIG. 1A). In the example shown in FIG. 4, the heating and/or cooling appliance 400 is a PTAC, which is a type of single-package unit that provides the indoor portion and outdoor portion in a horizontal configuration. A similar type of single-package unit that is provided in a vertical orientation is called a vertical terminal air conditioner (VTAC). PTAC units are often found within hotel and motel environments, as well as other environments that do not include ducted or central air conditioning. PTAC units are self-contained units installed through a wall. The compressor system of the PTAC provides both heating and cooling capabilities. To provide cooling capabilities, the compressor of the PTAC unit pumps refrigerant to cool the coils which attracts heat and humidity which is then exhausted to the outside environment. To provide heating capabilities, the reverse process is performed. The refrigerant is used to heat the coils, and when air passes over the coils, the PTAC unit pushes the heated air into the environment being heated.

Although FIG. 4 shows the compressor system as a sub-system of a PTAC, this is merely intended to illustrate an example of a heating and/or cooling appliance in which the compressor system (for example, the compressor system of FIG. 1A or any other compressor system) may be included. As indicated above, the compressor system and the clamps used to reduce the vibrations of the tubing may also be provided in any other type of air conditioning system or any other heating and/or cooling appliance in general that includes a compressor.

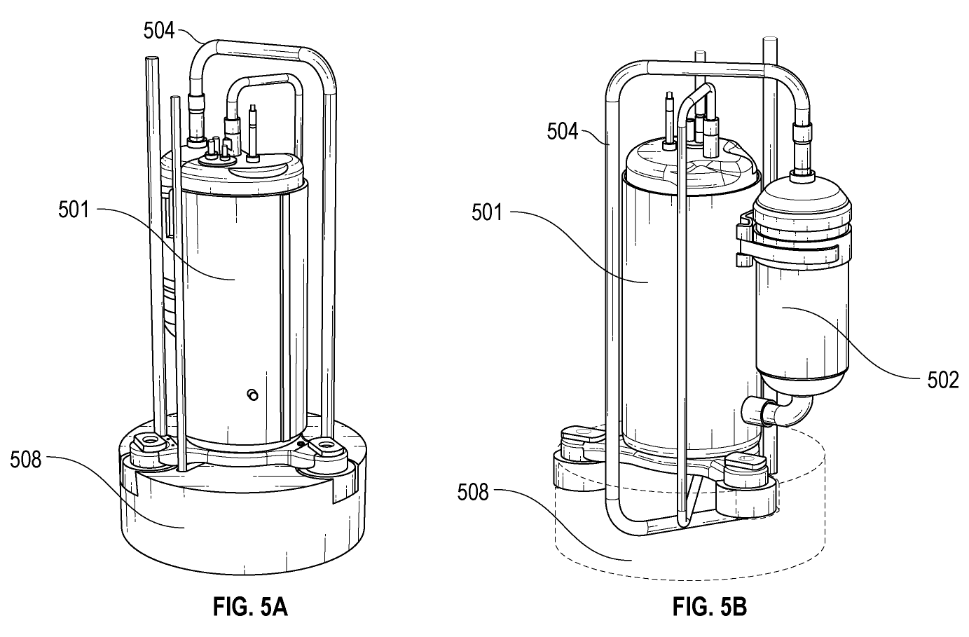

FIGS. 5A-5B illustrate perspective views of yet another compressor system 500 with a vibration reducing base 508 (similar to the compressor system 300 of FIGS. 3A-3B). Specifically, FIG. 5A shows the compressor system 500 with the vibration reducing base 508 as opaque and FIG. 5B shows the compressor system 500 with the vibration reducing base 508 as transparent such that compressor tubing 504 is visible within the vibration reducing base 508.

The compressor system 500 may be the same as, or similar to, the compressor system 100 shown in FIGS. 1A-1F (or any other compressor system described herein). That is, the compressor system 500 may include a compressor 501, an accumulator 502, and the tubing 504 that connects the various elements of the compressor system 500. Although not shown in FIGS. 5A-5B, the compressor system 500 may also include a reversing valve and/or any other elements that are traditionally found in a system including a compressor.

Similar to the vibration reducing base 308 shown in the compressor system 300, the vibration reducing base 508 restricts the movement of the tubing 504 during the operation of the compressor 501. The vibration reducing base 508 may be an elastomer or any other type of suitable material (this is also applicable to the vibration reducing base 308 of FIGS. 3A-3B). The embodiment allows the tubing 504 to be routed underneath the compressor 501 and provides an opportunity to double isolate the compressor structure from the base pan to which the compressor 501 is mounted. This may also provide the option to remove the tubing supports (for example, tubing supports 310, 312, 314, etc.) from the assembly and mount directly to and/or within the vibration reducing base 508. This provides another tubing routing option if adjacent components do not allow for more typical routing due to space constraints.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

We claim:

1. A system comprising:
a compressor;
compressor tubing in fluid communication with the compressor; and
a first clamp configured to be provided around the compressor, wherein the first clamp comprises one or more first tubing protrusions configured to receive the compressor tubing to reduce vibrations of the compressor tubing during operation of the compressor.

2. The system of claim 1, wherein the one or more first tubing protrusions are located at a distance from the compressor such that the compressor tubing is also located at the distance from the compressor.

3. The system of claim 1, further comprising a second clamp also configured to be provided around the compressor, wherein the second clamp comprises one or more second tubing protrusions configured to receive the compressor tubing.

4. The system of claim 1, wherein the first clamp comprises a first half and a second half, wherein the first half is configured to be removably attached to the second half.

5. The system of claim 1, wherein a portion of the one or more first tubing protrusions comprises sidewalls that angle inwards towards.

6. The system of claim 1, wherein the compressor tubing is brazed within the first one or more tubing protrusions of the first clamp.

7. The system of claim 1, wherein the first clamp is made from a material comprising at least one of: ethylene propylene diene terpolymer (EPDM), Neoprene, Silicone, or Polyurethane.

8. The system of claim 1, wherein the compressor tubing is also in fluid communication with an accumulator and a reversing valve.

9. An air conditioning unit comprising:
a compressor;
compressor tubing in fluid communication with the compressor; and
a first clamp configured to be provided around the compressor, wherein the first clamp comprises one or more first tubing protrusions configured to receive the compressor tubing to reduce vibrations of the compressor tubing during operation of the compressor.

10. The air conditioning unit of claim 9, wherein the one or more first tubing protrusions are located at a distance from the compressor such that the compressor tubing is also located at the distance from the compressor.

11. The air conditioning unit of claim 9, further comprising a second clamp also configured to be provided around the compressor, wherein the second clamp comprises one or more second tubing protrusions configured to receive the compressor tubing.

12. The air conditioning unit of claim 9, wherein the first clamp comprises a first half and a second half, wherein the first half is configured to be removably attached to the second half.

13. The air conditioning unit of claim 9, wherein a portion of the one or more first tubing protrusions comprises sidewalls that angle inwards towards.

14. The air conditioning unit of claim 9, wherein the compressor tubing is brazed within the one or more first tubing protrusions of the first clamp.

15. The air conditioning unit of claim 9, wherein the first clamp is made from a material comprising at least one of: ethylene propylene diene terpolymer (EPDM), Neoprene, Silicone, or Polyurethane.

16. The air conditioning unit of claim 9, wherein the compressor tubing is also in fluid communication with an accumulator and a reversing valve.

17. An apparatus for reducing vibrations of compressor tubing, the apparatus comprising:
a first half and a second half, wherein the first half is configured to be removably attached to the second half;
a void located between the first half and the second half, wherein the first half and the second half are configured to be combined around a compressor such that the compressor is positioned within the void; and
one or more first tubing protrusions configured to receive the compressor tubing to reduce vibrations of the compressor tubing during operation of the compressor.

18. The apparatus of claim 17, wherein the one or more first tubing protrusions are located at a distance from the compressor such that the compressor tubing is also located at the distance from the compressor.

19. The apparatus of claim 17, wherein a portion of the one or more first tubing protrusions comprises sidewalls that angle inwards towards.

20. The apparatus of claim 17, wherein the compressor tubing is brazed within the one or more first tubing protrusions of the apparatus.
